(19) United States
(12) Patent Application Publication
(10) Pub. No.: US 2025/0139467 A1
(43) Pub. Date: May 1, 2025

(54) DEVICE AND COMPUTER-IMPLEMENTED METHOD FOR PROVIDING, TESTING, VERIFYING, OR VALIDATING A FACT IN A DATABASE STRUCTURE, FOR LEARNING A CONFIDENCE FOR PROVIDING, TESTING, VERIFYING, OR VALIDATING A FACT IN A DATABASE STRUCTURE, OR PROVIDING THE DATABASE MANAGEMENT SYSTEM WITH A LEARNED CONFIDENCE

(71) Applicant: Robert Bosch GmbH, Stuttgart (DE)

(72) Inventors: Simon Josef Ott, WIEN (AT); Daria Stepanova, Leonberg (DE); Mohamed Gad-Elrab, Saarbruecken (DE)

(21) Appl. No.: 18/921,068

(22) Filed: Oct. 21, 2024

(30) Foreign Application Priority Data
Oct. 25, 2023 (DE) 10 2023 210 528.4

(51) Int. Cl. G06N 5/025

(52) U.S. Cl. CPC G06N 5/025

(57) ABSTRACT

Device and computer-implemented methods for providing, testing, verifying, or validating a fact in a database structure, in particular a knowledge graph that is stored in a database, wherein the database structure, wherein the fact includes two entities, and a relation. The method includes providing a first symbolic rule that is configured to predict the fact depending on one of the two entities and the relation, or depending on the two entities, wherein the first symbolic rule is associated with a first confidence, providing a second symbolic rule that is configured to predict the fact depending on one of the two entities and the relation, or depending on the two entities, wherein the second symbolic rule is associated with a second confidence, determining a score for the fact depending on the first confidence, and the second confidence, the score indicating whether the fact belongs to the database structure or not.

### CROSS REFERENCE

The present application claims the benefit under 35 U.S.C. § 119 of German Patent Application No. DE 10 2023 210 528.4 filed on Oct. 25, 2023, which is expressly incorporated herein by reference in its entirety.

### FIELD

The description relates to a device and a computer-implemented method for providing, testing, verifying, or validating a fact in a database structure, a computer-implemented method for learning a confidence for providing, testing, verifying, or validating a fact in a database structure, and a computer-implemented method for providing the database management system with the learned confidence.

### SUMMARY

According to an example embodiment of the present invention, a computer-implemented method for providing, testing, verifying, or validating a fact in a database structure, in particular a knowledge graph that is stored in a database, wherein the database structure, in particular the knowledge graph, comprises entities and relations, wherein the fact comprises two entities, and a relation, wherein the method comprises providing a first symbolic rule that is configured to predict the fact depending on one of the two entities and the relation, or depending on the two entities, wherein the first symbolic rule is associated with a first confidence, providing a second symbolic rule that is configured to predict the fact depending on one of the two entities and the relation, or depending on the two entities, wherein the second symbolic rule is associated with a second confidence, determining a score for the fact depending on the first confidence, and the second confidence, in particular with a function for determining the score depending on the first confidence and the second confidence, wherein the score indicates whether the fact belongs to the database structure or not, and providing, testing, verifying, or validating the fact in the database structure depending on the score. The score that depends on the first confidence and the second confidence correlates the confidences of the first symbolic rule and the second symbolic rule.

According to an example embodiment of the present invention, the method may comprise determining the score for a plurality of facts for the database structure, in particular the knowledge graph, wherein the facts of the plurality of facts respectively comprise two entities and a relation of the database structure, wherein the plurality of facts comprises the fact, and wherein the method comprises selecting the fact from the plurality of facts depending on the scores that are determined for the plurality of facts, wherein the score that is determined for the selected fact indicates a higher probability that the fact belongs into the database structure, or a higher probability that the fact not belongs to the database structure, than the score that is determined for at least one other fact of the plurality of facts, in particular indicates the highest probability that is determined for the facts of the plurality of facts.

According to an example embodiment of the present invention, providing the fact may comprise adding the fact to the database structure, in particular when the score that is determined for the fact indicates that the fact belongs into the database structure. Testing, verifying, or validating the fact may comprise searching the fact in the database structure, and either confirming the fact in the database structure in case the fact is found, in particular when the score that is determined for the fact indicates that the fact belongs into the database structure, or invalidating the fact in the database structure or removing the fact from the database structure, in particular when the score that is determined for the fact indicates that the fact not belongs into the database structure.

According to an example embodiment of the present invention, a computer-implemented method for learning a first confidence and/or a second confidence for providing, testing, verifying, or validating a fact in a database structure, in particular a knowledge graph, wherein the database structure, in particular the knowledge graph, comprises entities and relations, wherein the fact comprises two entities, and a relation, wherein the method comprises providing a first symbolic rule that is configured to predict the fact depending on one of the two entities and the relation, or depending on the two entities, wherein the first symbolic rule is associated with the first confidence, providing a second symbolic rule that is configured to predict the fact depending on one of the two entities and the relation, or depending on the two entities, wherein the second symbolic rule is associated with the second confidence, and learning the first confidence and/or the second confidence depending on a loss, wherein the loss comprises a function for determining a score depending on the first confidence, and the second confidence, wherein the score indicates whether the fact belongs to the database structure or not. The first confidence and/or the second confidence are learned directly.

According to an example embodiment of the present invention, the method for learning may comprise providing a plurality of symbolic rules that are configured to map an entity and a relation of the database structure to an entity of the database structure, or to map two entities of the database structure to a relation of the database structure, wherein the symbolic rules of the plurality of symbolic rules are associated with a respective confidence, determining selected symbolic rules that predict the fact from the plurality of symbolic rules, wherein the selected symbolic rules comprise the first symbolic rule and the second symbolic rule, and learning the confidences that are associated with the selected symbolic rules depending on the loss, wherein the function in the loss depends on the respective confidences that are associated with the selected symbolic rules. The selected symbolic rules actually predict the fact. The ruleset comprising the plurality of symbolic rules is improved depending on the correlated confidences of the rules that actually predict the fact. Symbolic rules not predicting the fact are ignored.

According to an example embodiment of the present invention, the method for learning may comprise providing, for at least one function in the loss, a reference, wherein the reference indicates whether the fact belongs to the database structure or not, wherein the loss depends on the reference for the at least one function. The reference provides supervised learning.

According to an example embodiment of the present invention, the loss may comprise for a plurality of facts a respective function, or in that the method comprises providing the reference for a plurality of facts, wherein the loss comprises for a plurality of facts a respective function, and depends on the reference for the plurality of facts.

According to an example embodiment of the present invention, a computer-implemented method for providing a database management system for managing a database structure, wherein the method for providing the database management system comprises learning a first confidence and/or a second confidence for providing, testing, verifying, or validating a fact in the database structure, in particular a knowledge graph, in particular with the method for learning the first confidence and/or the second confidence for providing, testing, verifying, or validating a fact in the database structure, and providing the database management system with the learned first confidence and/or second confidence, and with means for providing, testing, verifying, or validating a fact in a database structure with the method for providing, testing, verifying, or validating a fact in a database structure.

According to an example embodiment of the present invention, a device comprises at least one processor and at least one memory, wherein the at least one processor is configured to execute instructions that, when executed by the at least one processor, cause the device to execute, method for providing, testing, verifying, or validating the fact in the database structure, method for learning the first confidence and/or the second confidence for providing, testing, verifying, or validating the fact in the database structure, the method for providing the database management system for managing the database structure, wherein the at least one memory stores the instructions.

According to an example embodiment of the present invention, a database structure, in particular knowledge graph, that is stored in a database, comprises entities, and relations, and facts, wherein a fact comprises two entities, and a relation, wherein the database structure comprises a first symbolic rule that is configured to predict the fact depending on one of the two entities and the relation, or depending on the two entities, wherein the database structure comprises a first confidence, and wherein the first symbolic rule is associated with the first confidence, wherein the database structure comprise a second symbolic rule that is configured to predict the fact depending on one of the two entities and the relation, or depending on the two entities, wherein the database structure comprises a second confidence, wherein the second symbolic rule is associated with the second confidence, wherein the database structure comprises a loss for learning the first confidence and/or the second confidence, wherein the loss comprises a function for determining a score depending on the first confidence, and the second confidence, wherein the score indicates whether the fact belongs to the database structure or not.

According to an example embodiment of the present invention, a computer program comprises computer-readable instructions that, when executed by a computer, cause the computer to execute the method for providing, testing, verifying, or validating a fact in a database structure, the method for learning and/or the method for providing a database management system.

Further embodiments of the present invention are derived from the following description and the figures.

### BRIEF DESCRIPTION OF THE DRAWINGS

FIG. 1 schematically depicts a device, according to an example embodiment of the present invention.

FIG. 2 schematically depicts a data base structure, according to an example embodiment of the present invention.

FIG. 3 depicts a flow chart comprising steps of a method for providing, testing, verifying, or validating a fact in the database structure, according to an example embodiment of the present invention.

FIG. 4 depicts a flow chart comprising steps of a method for learning a confidence for providing, testing, verifying, or validating the fact in the database structure, according to an example embodiment of the present invention.

FIG. 5 depicts a flow chart comprising steps of a method for providing a database management system, according to an example embodiment of the present invention.

### DETAILED DESCRIPTION OF EXAMPLE EMBODIMENTS

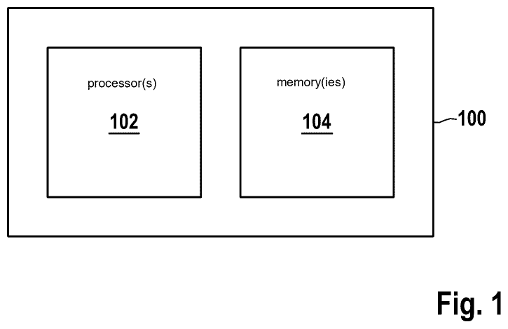

FIG. 1 schematically depicts a device 100.

The device 100 comprises at least one processor 102 and at least one memory 104.

The at least one processor 102 is configured to execute instructions.

The instructions, when executed by the at least one processor 102, may cause the device 100 to execute a method for providing, testing, verifying, or validating a fact in a database structure.

The instructions, when executed by the at least one processor 102, may cause the device 100 to execute a method for learning a confidence for providing, testing, verifying, or validating the fact in the database structure.

The instructions, when executed by the at least one processor 102, may cause the device 100 to execute a method for providing a database management system.

The at least one memory 104 stores the instructions.

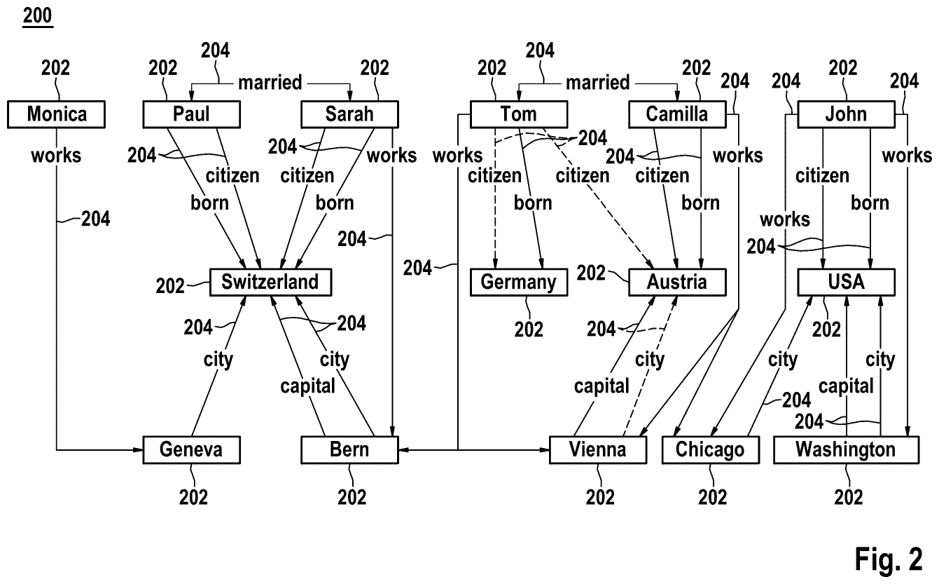

FIG. 2 schematically depicts an example 200 for a part of the data base structure.

The database structure in the example 200 comprises a knowledge graph G=⊂{p(s,o)|p∈P,s,o∈C} as a set of ground atoms or facts defined on top of a signature [symbol] C,P [symbol] , wherein C is a set of constants, i.e., entities, and P is a set of predicates, i.e., relations, and wherein a fact t=p(s,o), comprises two entities, i.e., a subject s, and an object o, and a relation, i.e., a predicate p.

The database structure, e.g., the knowledge graph, in the example is stored in a database. The at least one memory 104 in the example comprises the database.

FIG. 2 schematically depicts exemplary entities 202, and relations 204 or the database structure.

FIG. 2 depicts exemplary relations 204 labelled citizen, born, works, city, capital, married, and exemplary entities 202 labelled monica, paul, sarah, tom, camilla, john, switzerland, germany, austria, usa, geneva, bern, vienna, chicago, Washington. FIG. 2 depicts exemplary facts t:
works (monica, geneva),
city (geneva, switzerland),
citizen (paul, switzerland),
born (paul, switzerland),
married (paul, sarah),
citizen (sarah, switzerland),
born (sarah, switzerland),
works (sarah, bern),
city (bern, switzerland),
capital (bern, switzerland),
works (tom, bern),
works (tom, vienna),
born (tom, germany),
married (tom, camilla),
citizen (camilla, austria),
born (camilla, austria),
capital (vienna, austria),
works (camilla, vienna),
works (camilla, chicago),
works (john, chicago),
citizen (john, usa),
born (john, usa),
city (chicago, usa),
city (washington, usa),
capital (washington, usa),
works (john, washington).

The database structure may be incomplete. For example, the knowledge graph is incomplete. In FIG. 2, dashed edges correspond to the following examples for missing facts:
citizen (tom, austria),
citizen (tom, germany),
city (vienna, austria).

The problem of knowledge graph completion is concerned with defining an automated procedure for finding missing facts solely by analyzing a statistical distributions and regularities of the given knowledge graph.

Missing facts may be found with queries that comprise an entity and a relation or with queries that comprise two entities. In the example described herein, missing facts are found with queries that comprise a relation and an entity. Queries comprising two entities may be used accordingly.

Missing facts are for example found with queries p(s,?), e.g., such as citizen(tom,?) and/or queries p(?,o), e.g., such as citizen(?,Austria), wherein ? is a placeholder for the entity of the missing fact.

A model may be used to predict answers in the form of candidate facts p(s,o), e.g., such as citizen(tom, germany), or citizen (tom, switzerland) and assigns plausibility scores to these answers. A ranking of the candidate facts may be formed, and the highest ranking candidate fact may be used as missing fact. The model for example predicts a score for ranking the candidate facts such that the higher the score for a candidate fact is, the more likely it is that the candidate fact is the missing fact.

The candidate facts may be found based on symbolic rules R. The symbolic rules R are configured to predict candidate facts t depending on two entities 202.

A symbolic rule r∈R in the example is configured to map a first entity 202 and a relation 204 of the database structure to a second entity 202 of the database structure. According to the example, the symbolic rule r comprises a condition that, when the first entity 202, the second entity 202 and the relation 204 meet the condition, maps the first entity 202, and the relation 204 to the second entity 202.

The symbolic rule r may be configured to map two entities 202 of the database structure to a relation 202 of the database structure. The symbolic rule r may be configured to map a plurality of entities 202 and/or a plurality of relations 204 to an entity 202. The symbolic rule r may comprise a condition that, when the first entity 202, the second entity 202 and the relation 204 meet the condition, maps the first entity 202, and the second entity 202 to the relation 204.

Rules may be determined depending on the database structure, e.g., the knowledge graph. An example for determining rules is described in Christian Meilicke, Melisachew Wudage Chekol, Daniel Ruffinelli, and Heiner Stuckenschmidt, “Anytime bottom-up rule learning for knowledge graph completion;” in Proceedings of the Twenty-Eighth International Joint Conference on Artificial Intelligence, pages 3137-3143. Ijcai.org, 2019 (AnyBURL). An example for determining rules is disclosed in Luis Galárraga, Christina Teflioudi, Katja Hose, and Fabian M Suchanek, “Fast rule mining in ontological knowledge bases with AMIE+;” the VLDB Journal, 24 (6): 707-730, 2015 (AMIE).

According to an example, four rules r₁, r₂, r₃, r₄ are defined
r₁:a(X,Y)←b(X,Y)
r₂:a(X,Y)←c(X,A),d(A,Y)
r₃:a(X,Y)←c(X,A),e(A,Y)
r₄: a(X,Y)←f(X,A),a(A,Y)
   wherein a, b, c, d, e, f, are relations 204, and X, Y, A are variables representing entities 202. The rule rᵢ comprise a head, e.g., the predicted fact t that comprises the first entity 202, the second entity 202, and the relation 204, left of the ←. The rule rᵢ comprises a tail right of the ←. The rule rᵢ maps the tail to the head, in case entities 202 are found for the variables, such that the relations in the tail exist in the database structure.

An example for the four rules r₁, . . . , r₄ for the example 200 may be:
r₁:citizen(X,Y)←born(X,Y)
r₂:citizen(X,Y)←works(X,A),city(A,Y)
r₃:citizen(X,Y)←works(X,A),capital(A,Y)
r₄:citizen(X,Y)←married(X,A),citizen(A,Y)
   wherein a=citizen, b=born, c=works, d=city, e=capital, f=married.

The rules rᵢ are associated with a respective confidence cᵢ that indicates whether the fact tᵢ predicted by the respective rule rᵢ∈R belongs to the database structure or not. According to an example, the confidence cᵢ∈[0,1] is used. The confidence cᵢ may be defined on a different set of values than [0,1]. The rules rᵢ are associated with a respective score sᵢ that indicates whether the fact predicted by the respective rule rᵢ belongs to the database structure or not. The score sᵢ for a respective fact tᵢ is determined depending on the confidences cⱼ of the rules rⱼ∈R.

According to an example, the confidences cⱼ for the rules rⱼ have been learned on training data D={(yᵢ,xᵢ)}ᵢ₌₁^{N}, wherein N is the number of facts tᵢ predicted by rules in R, wherein the variable yᵢ=1 if the fact tᵢ is seen in the training data D and yᵢ=0 otherwise, and xᵢ=(xᵢ₁, . . . , xᵢⱼ, . . . , x_{iK}) is a binary vector, wherein xᵢⱼ=1 if the rule rⱼ predicted the fact tᵢ and xᵢⱼ=0 otherwise.

The confidences cⱼ have for example been learned with a loss

$$L ( w ) = - {\sum }_{i = 1}^{N} {y}_{i} log P ( {y}_{i} \vert {x}_{i} ; w ) + ( 1 - {y}_{i} ) log ( 1 - P ( {y}_{i} \vert {x}_{i} ; w ) )$$

The loss L(w) comprises a function

$${s}_{i} = P ( {y}_{i} \vert {x}_{i} ; w ) = 1 - {\prod }_{j = 1}^{K} ( 1 - {x}_{i j} {c}_{j} )$$

for determining the score sᵢ for a respective fact tᵢ depending on the respective confidences cⱼ=σ(wⱼ). The loss L(w) depends on respective reference yᵢ for the respective function P(yᵢ|xᵢ;w).

This means, the confidences cⱼ are expressed with a real-valued parameter, i.e., weight wⱼ, and the sigmoid function σ.

The loss in the example is smooth and differentiable with respect to the parameter wⱼ. The learning may employ gradient-based optimization techniques on the loss.

The model for example comprises the parameter wⱼ and is configured to predict the scores sᵢ.

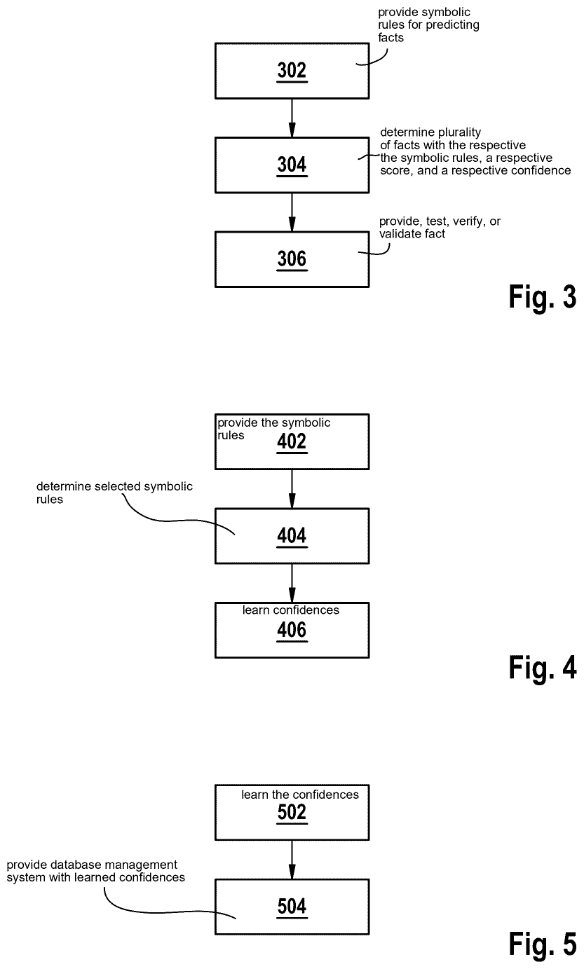

FIG. 3 depicts a method for providing, testing, verifying, or validating a fact t in the database structure, in particular the knowledge graph.

The method comprises a step 302.

The step 302 comprises providing the symbolic rules R for predicting facts {t₁, . . . , t_{N}}. The symbolic rules R are determined for example on the database structure, e.g., the knowledge graph, with AnyBURL or AMIE.

A respective symbolic rule n ER is configured to predict a respective fact t∈{t₁, . . . , t_{N}}. A respective symbolic rule rᵢ∈R is associated with a respective confidence cᵢ.

The method comprises a step 304.

The step 304 comprises determining a plurality of facts {t₁, . . . , t_{N}} with the respective symbolic rules rᵢ∈R, and a respective score sᵢ for a respective fact tᵢ.

The score sᵢ for the fact tᵢ is for example determined with the function for determining the score si depending on the confidences cᵢ of the rules r that predicted the fact tᵢ:

$${s}_{i} = 1 - {\prod }_{j = 1}^{K} ( 1 - {x}_{i j} {c}_{j} )$$

wherein xᵢ=(xᵢ₁, . . . , xᵢⱼ . . . , x_{iK}) is a binary vector, wherein xᵢⱼ=1 if the rule rⱼ predicted the fact tᵢ and xᵢⱼ=0 otherwise.

The confidences cᵢ in the example are learned confidences cᵢ. According to an example, the scores sᵢ are determined with the model depending on the learned confidences cᵢ.

The symbolic rules R comprise for example a first symbolic rule r₁ that is configured to predict the fact tᵢ. The first symbolic rule r₁ is associated with a first confidence c₁. The symbolic rules R comprise a second symbolic rule r₂ that is configured to predict the fact tᵢ. The second symbolic rule r₂ is associated with a second confidence c₂.

The score sᵢ for the fact tᵢ is for example determined depending on the first confidence c₁, and the second confidence c₂.

The score sᵢ indicates whether the fact tᵢ belongs to the database structure or not.

The method comprises a step 306.

The step 306 comprises providing, testing, verifying, or validating the fact tᵢ in the database structure depending on the score.

Providing the fact tᵢ may comprise selecting the fact tᵢ from the plurality of facts depending on the scores that are determined for the plurality of facts.

Providing the fact tᵢ may comprise selecting the fact tᵢ that has the highest score. Providing the fact tᵢ may comprise selecting the fact tᵢ that has a higher score than other facts of the plurality of facts. Providing the fact tᵢ may comprise selecting facts that have the highest score or that have a higher score than other facts of the plurality of facts.

In the example, the score that is determined for the selected fact indicates a higher probability that the fact belongs into the database structure than the score that is determined for at least one other fact of the plurality of facts.

Providing the fact may comprise adding the fact to the database structure, in particular when the score that is determined for the fact indicates that the fact belongs into the database structure. According to the example, the fact or the facts associated with the highest score or with a higher score than other facts is added.

The example is not limited to the case wherein a higher probability indicates that the fact belongs into the database structure. According to an example, a higher probability may indicate that the fact not belongs to the database structure.

Accordingly, the fact or the facts associated with the lowest score or with a lower score than other facts may be added.

Testing, verifying, or validating the fact may comprises searching the fact in the database structure, and either confirming the fact in the database structure in case the fact is found, in particular when the score that is determined for the fact indicates that the fact belongs into the database structure, or invalidating the fact in the database structure or removing the fact from the database structure, in particular when the score that is determined for the fact indicates that the fact not belongs into the database structure.

FIG. 4 depicts a flow chart comprising steps of a computer-implemented method for learning the confidences cᵢ for providing, testing, verifying, or validating the fact in the database structure.

The method comprises a step 402.

The step 402 comprises providing the symbolic rules R.

The symbolic rules R are for example provided as described in step 302. The symbolic rules R are associated with a respective confidence cᵢ.

The step 402 comprises providing respective references yᵢ for the scores sᵢ.

The reference yᵢ indicates for the fact tᵢ whether the fact tᵢ belongs to the database structure or not.

For example, the training data D is provided.

The reference yᵢ is for example the yᵢ=1 if the fact tᵢ is seen in the training data D and yᵢ=0 otherwise.

The method comprises a step 404.

The step 404 comprises determining selected symbolic rules rⱼ that predict the fact from the plurality of symbolic rules.

The selected symbolic rules are for example identified with the binary vector xᵢ=(xᵢ₁, . . . , xᵢⱼ, . . . , x_{iK}), wherein xᵢⱼ=1 if the rule rⱼ predicted the fact tᵢ and xᵢⱼ=0 otherwise.

The method comprises a step 406.

The step 406 comprises learning the confidences cᵢ depending on the loss L(w).

The step 406 comprises learning the confidences cⱼ that are associated with the selected symbolic rules rⱼ depending on the loss L(w).

The loss depends on the respective functions that are associated with the selected symbolic rules rⱼ. The loss depends on the respective confidences cⱼ that are associated with the selected symbolic rules rⱼ.

The learning for example employs gradient-based optimization techniques on the loss L(w). For example, the confidences cⱼ are determined that minimize the loss L(w).

FIG. 5 schematically depicts a method for providing a database management system for managing the database structure.

The method for providing the database management system comprises a step 502.

The step 502 comprises learning the confidences cⱼ, in particular with the method for learning the confidences cⱼ.

The method for providing the database management system comprises a step 504.

The step 504 comprises providing the database management system with the learned confidences cⱼ.

The step 504 comprises providing the database management system means for providing, testing, verifying, or validating a fact in the database structure with the method for providing, testing, verifying, or validating a fact in a database structure.

The means for providing, testing, verifying, or validating a fact in the database structure may comprise the at least one processor 102, and the at least one memory 104.

What is claimed is:

1. A computer-implemented method for providing or testing or verifying or validating a fact in a database structure, the data structure including a knowledge graph that is stored in a database, the database structure including entities and relations, wherein the fact includes two entities and a relation, the method comprising the following steps:
providing a first symbolic rule that is configured to predict the fact depending on one of the two entities and the relation, or depending on the two entities, wherein the first symbolic rule is associated with a first confidence;
providing a second symbolic rule that is configured to predict the fact depending on one of the two entities and the relation, or depending on the two entities, wherein the second symbolic rule is associated with a second confidence;
determining a respective score for the fact depending on the first confidence and the second confidence, using a function for determining the score depending on the first confidence and the second confidence, wherein the score indicates whether the fact belongs to the database structure or not; and
providing or testing or verifying or validating the fact in the database structure depending on the score.

2. The method according to claim 1, further comprising:
determining a respective score for each of a plurality of facts for the database structure, wherein the facts of the plurality of facts respectively each include two entities and a relation of the database structure, wherein the plurality of facts includes the fact;
selecting the fact from the plurality of facts depending on the respective scores that are determined for the plurality of facts, wherein the score that is determined for the selected fact indicates a higher probability that the fact belongs into the database structure, or a higher probability that the fact not belongs to the database structure, than the score that is determined for at least one other fact of the plurality of facts, which indicates a highest probability that is determined for the facts of the plurality of facts.

3. The method according to claim 2, wherein:
the providing of the fact includes adding the fact to the database structure when the score that is determined for the fact indicates that the fact belongs into the database structure, or
the testing or verifying or validating the fact includes searching the fact in the database structure, and either confirming the fact in the database structure in case the fact is found when the score that is determined for the fact indicates that the fact belongs into the database structure, or invalidating the fact in the database structure or removing the fact from the database structure when the score that is determined for the fact indicates that the fact does not belong into the database structure.

4. A computer-implemented method for learning a first confidence and/or a second confidence for providing, testing, verifying, or validating a fact in a database structure including a knowledge graph, the database structure including entities and relations, wherein the fact includes two entities and a relation, the method comprising the following steps:
providing a first symbolic rule that is configured to predict the fact depending on one of the two entities and the relation, or depending on the two entities, wherein the first symbolic rule is associated with the first confidence;
providing a second symbolic rule that is configured to predict the fact depending on one of the two entities and the relation, or depending on the two entities, wherein the second symbolic rule is associated with the second confidence; and
learning the first confidence and/or the second confidence depending on a loss, wherein the loss includes a function for determining a score depending on the first confidence, and the second confidence, wherein the score indicates whether the fact belongs to the database structure or not.

5. The method according to claim 4, further comprising:
providing a plurality of symbolic rules that are configured to map an entity and a relation of the database structure to an entity of the database structure, or to map two entities of the database structure to a relation of the database structure, wherein each of the symbolic rules of the plurality of symbolic rules is associated with a respective confidence;
determining selected symbolic rules that predict the fact from the plurality of symbolic rules, wherein the selected symbolic rules include the first symbolic rule and the second symbolic rule; and
learning the confidences that are associated with the selected symbolic rules depending on the loss, wherein the function in the loss depends on the respective confidences that are associated with the selected symbolic rules.

6. The method according to claim 4, further comprising:
providing, for at least one function in the loss, a reference, wherein the reference indicates whether the fact belongs to the database structure or not, wherein the loss depends on the reference for the at least one function.

7. The method according to claim 6, wherein:
the loss includes, for each a plurality of facts, a respective function, or
the method further comprises providing the reference for a plurality of facts, wherein the loss includes for each of a plurality of facts, a respective function, and depends on the reference for the plurality of facts.

8. A computer-implemented method for providing a database management system for managing a database structure, the method comprising:
learning a first confidence and/or a second confidence for providing or testing or verifying or validating a fact in the database structure, the data base including a knowledge graph, the database structure including entities and relations, wherein the fact includes two entities and a relation, the learning including:
providing a first symbolic rule that is configured to predict the fact depending on one of the two entities and the relation, or depending on the two entities, wherein the first symbolic rule is associated with the first confidence,
providing a second symbolic rule that is configured to predict the fact depending on one of the two entities and the relation, or depending on the two entities, wherein the second symbolic rule is associated with the second confidence, and
learning the first confidence and/or the second confidence depending on a loss, wherein the loss includes a function for determining a score depending on the first confidence, and the second confidence, wherein the score indicates whether the fact belongs to the database structure or not;
providing the database management system with the learned first confidence and/or second confidence; and
providing the database management system with an arrangement for providing or testing or verifying or validating a fact in the database structure with a method including the following steps:
providing a first symbolic rule that is configured to predict the fact depending on one of the two entities and the relation, or depending on the two entities, wherein the first symbolic rule is associated with a first confidence,
providing a second symbolic rule that is configured to predict the fact depending on one of the two entities and the relation, or depending on the two entities, wherein the second symbolic rule is associated with a second confidence,
determining a respective score for the fact depending on the first confidence and the second confidence, using a function for determining the score depending on the first confidence and the second confidence, wherein the score indicates whether the fact belongs to the database structure or not, and
providing or testing or verifying or validating the fact in the database structure depending on the score.

9. A device, comprising:
at least one processor; and
at least one memory;
wherein the at least one processor is configured to execute instructions that, when executed by the at least one processor, cause the device to perform method for providing or testing or verifying or validating a fact in a database structure, the data structure including a knowledge graph that is stored in a database, the database structure including entities and relations, wherein the fact includes two entities and a relation, the method including the following steps:
providing a first symbolic rule that is configured to predict the fact depending on one of the two entities and the relation, or depending on the two entities, wherein the first symbolic rule is associated with a first confidence,
providing a second symbolic rule that is configured to predict the fact depending on one of the two entities and the relation, or depending on the two entities, wherein the second symbolic rule is associated with a second confidence,
determining a respective score for the fact depending on the first confidence and the second confidence, using a function for determining the score depending on the first confidence and the second confidence, wherein the score indicates whether the fact belongs to the database structure or not, and
providing or testing or verifying or validating the fact in the database structure depending on the score;
wherein the at least one memory stores the instructions.

10. A database structure, including a knowledge graph, stored in a database, the database structure comprising:
entities;
relations;
facts, wherein each fact includes two entities and a relation;
a first symbolic rule that is configured to predict the fact depending on one of the two entities and the relation, or depending on the two entities;
a first confidence, and wherein the first symbolic rule is associated with the first confidence;
a second symbolic rule that is configured to predict the fact depending on one of the two entities and the relation, or depending on the two entities;
a second confidence, wherein the second symbolic rule is associated with the second confidence; and
a loss for learning the first confidence and/or the second confidence, wherein the loss includes a function for determining a score depending on the first confidence, and the second confidence, wherein the score indicates whether the fact belongs to the database structure or not.

11. A non-transitory computer-readable medium on which is stored a computer program including computer-readable instructions for providing or testing or verifying or validating a fact in a database structure, the data structure including a knowledge graph that is stored in a database, the database structure including entities and relations, wherein the fact includes two entities and a relation, the instructions, when executed by a computer, causing the computer to perform the following steps:
providing a first symbolic rule that is configured to predict the fact depending on one of the two entities and the relation, or depending on the two entities, wherein the first symbolic rule is associated with a first confidence;
providing a second symbolic rule that is configured to predict the fact depending on one of the two entities and the relation, or depending on the two entities, wherein the second symbolic rule is associated with a second confidence;
determining a respective score for the fact depending on the first confidence and the second confidence, using a function for determining the score depending on the first confidence and the second confidence, wherein the score indicates whether the fact belongs to the database structure or not; and
providing or testing or verifying or validating the fact in the database structure depending on the score.
